(19) United States
(12) Patent Application Publication
(10) Pub. No.: US 2018/0134515 A1
(43) Pub. Date: May 17, 2018

(54) ELEVATOR OPERATION PANEL

(71) Applicant: MITSUBISHI ELECTRIC CORPORATION, Chiyoda-ku (JP)

(72) Inventor: Mao HIRATA, Chiyoda-ku (JP)

(73) Assignee: MITSUBISHI ELECTRIC CORPORATION, Chiyoda-ku (JP)

(21) Appl. No.: 15/580,157

(22) PCT Filed: Jul. 1, 2015
(86) PCT No.: PCT/JP2015/069037

§ 371 Date: Dec. 6, 2017

(51) Int. Cl. B66B 3/00; B66B 1/46; H04R 1/02

(52) U.S. Cl. CPC B66B 3/002; B66B 1/468; B66B 2201/463; H04R 1/028; B66B 3/004

(57) ABSTRACT

Provided is an elevator operation panel including: a casing having an opening portion; an acoustic device configured to output a sound, for example, a buzzer sound, from an inside of the casing; a face plate having formed therein a plurality of sound emission holes for allowing the sound output from the acoustic device to pass therethrough, and having a back surface that faces the casing to close the opening portion; and an operation button formed on the face plate and to be operated to cause an elevator to perform a specific operation. The plurality of sound emission holes are arranged so that a type of the operation button is identifiable when the face plate is touched from a front surface side.

### TECHNICAL FIELD

The present invention relates to an elevator operation panel to be installed at a landing or in a car, for example.

### BACKGROUND ART

In a related-art elevator operation panel, in order for a sound of a buzzer mounted in the operation panel to be easily heard to the outside, a plurality of sound emission holes for allowing the sound of the buzzer to pass therethrough are formed in a face plate (for example, see Patent Literature 1).

### CITATION LIST

### Patent Literature

[PTL 1] JP 07-242375 A

### SUMMARY OF INVENTION

### Technical Problem

In some case, the related-art elevator operation panel is configured so that not only physically unimpaired people but also visually impaired people can use the elevator operation panel. In those cases, in addition to the plurality of sound emission holes formed in the face plate, Braille protrusions and the like are required to be separately formed on a front surface of the face plate so that the visually impaired people can identify a type of an operation button by touching the face plate.

The present invention has been made to solve the above-mentioned problem, and has an object to provide an elevator operation panel that can be used by visually impaired people even without separately forming Braille protrusions and the like on a front surface of a face plate having a plurality of sound emission holes formed therein.

### Solution to Problem

According to one embodiment of the present invention, there is provided an elevator operation panel including: a casing having an opening portion; an acoustic device configured to output a sound from an inside of the casing; a face plate having formed therein a plurality of sound emission holes for allowing the sound output from the acoustic device to pass therethrough, and having a back surface that faces the casing to close the opening portion; and an operation button formed on the face plate and to be operated to cause an elevator to perform a specific operation, the plurality of sound emission holes being arranged so that a type of the operation button is identifiable when the face plate is touched from a front surface side.

### Advantageous Effects of Invention

According to the elevator operation panel of one embodiment of the present invention, the plurality of sound emission holes formed in the face plate are arranged so that the type of the operation button can be identified when the faceplate is touched from the front surface side. With this arrangement, it is possible to obtain the elevator operation panel that can be used by the visually impaired people even without separately forming Braille protrusions and the like on the front surface of the face plate having the plurality of sound emission holes formed therein.

### BRIEF DESCRIPTION OF DRAWINGS

FIG. 1 is a front view for illustrating an elevator landing operation panel according to a first embodiment of the present invention.

FIG. 2 is a sectional view taken along the line A-A of FIG.

FIG. 3 is a front view for illustrating an elevator landing operation panel according to a second embodiment of the present invention.

FIG. 4 is a sectional view for illustrating an elevator landing operation panel according to a third embodiment of the present invention.

### DESCRIPTION OF EMBODIMENTS

Now, an elevator operation panel according to exemplary embodiments of the present invention is described with reference to the drawings. In the illustration of the drawings, the same or corresponding components are denoted by the same reference symbols, and the overlapping description thereof is herein omitted.

### First Embodiment

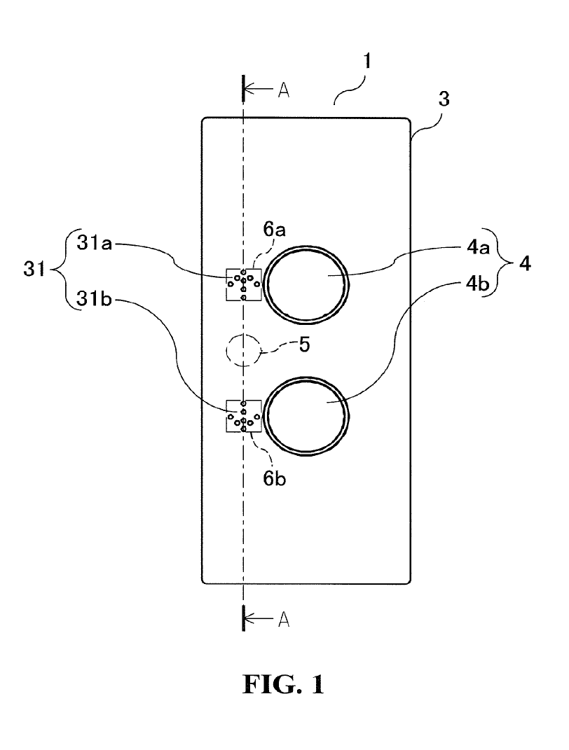

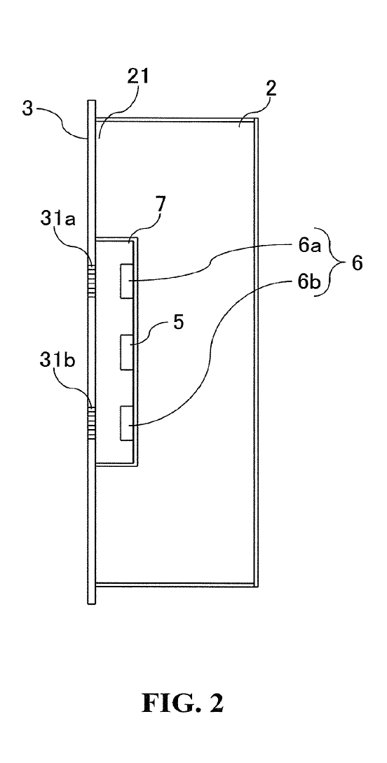

FIG. 1 is a front view for illustrating an elevator landing operation panel 1 according to a first embodiment of the present invention. FIG. 2 is a sectional view taken along the line A-A of FIG. 1. The landing operation panel 1 is installed on a front wall of an elevator landing.

The landing operation panel 1 includes a casing 2 having an opening portion 21, a face plate 3 that closes the opening portion 21, an operation button 4 formed on the face plate 3, an acoustic device 5 present in the casing 2, and a light-emitting device 6 present in the casing 2.

The casing 2 is configured to accommodate a plurality of electric components used for the landing operation panel 1. The opening portion 21 having a rectangular shape is formed in the casing 2.

The face plate 3 closes the opening portion 21 so that, of a front surface and a back surface of the face plate 3, the back surface faces the casing 2. Further, the face plate 3 is removably mounted to the casing 2.

The operation button 4 is operated by a passenger of the elevator so as to cause the elevator to perform a specific operation, and has various types such as a call button for calling an ascending car and a call button for calling a descending car. Further, the operation button 4 is electrically connected to a control device (not shown) configured to control the elevator. When the passenger presses the operation button 4, the control device controls the elevator so as to perform a specific operation corresponding to the operation button 4.

Specifically, the operation button 4 includes a first call button 4a to be operated by the passenger when his or her destination floor is a higher floor and a second call button 4b to be operated by the passenger when his or her destination floor is a lower floor. When the passenger presses the first call button 4a, the elevator performs, as the specific operation, an operation of causing the ascending car to land at the landing. Further, when the passenger presses the second call button 4b, the elevator performs, as the specific operation, an operation of causing the descending car to land at the landing.

The acoustic device 5 is present in the casing 2. Specifically, as illustrated in FIG. 2, a support portion 7 is mounted to the back surface of the face plate 3. The support portion 7 is configured to support the acoustic device 5 so that the acoustic device 5 is opposed to the back surface of the face plate 3 with an interval between the acoustic device 5 and the face plate 3. With this configuration, when the opening portion 21 is closed with the face plate 3, the acoustic device 5 is present in the casing 2. Further, the acoustic device 5 is configured with use of, for example, a buzzer device, which outputs a buzzer sound from the inside of the casing 2 as a response to the operation on the operation button 4. The acoustic device 5 may output an announce sound or other sounds.

A plurality of sound emission holes 31 are formed in the face plate 3 so as to allow a sound output from the acoustic device 5 to pass therethrough. Each of the plurality of sound emission holes 31 passes through the face plate 3. Forming the plurality of sound emission holes 31 in the face plate 3 enables the sound of the acoustic device 5 in the casing 2 to be easily heard to the outside of the casing 2 even when the opening portion 21 is closed with the face plate 3.

With this configuration, when the passenger presses the operation button 4 to register a call, the sound output from the acoustic device 5 passes through the plurality of sound emission holes 31 to be heard by the passenger. Therefore, the passenger can hear the sound to recognize that the call has been registered.

The plurality of sound emission holes 31 are arranged so that the visually impaired people can identify the type of the operation button 4 when the visually impaired people touch the face plate 3 from the front surface side. Therefore, by touching the plurality of sound emission holes 31, the visually impaired people can identify the type of the operation button 4, and recognize details of the elevator operation to be performed by operating the operation button 4. The diameter of each of the plurality of sound emission holes 31 may be set to a size at which each hole is identifiable when the hole is touched with a hand.

For example, when the operation button 4 is configured as described above, first sound emission holes 31a corresponding to the first call button 4a and second sound emission holes 31b corresponding to the second call button 4b are arranged as the plurality of sound emission holes 31.

The first sound emission holes 31a are arranged so that the visually impaired people can identify the type of the first call button 4a when the visually impaired people touch the face plate 3 from the front surface side. Therefore, by touching the first sound emission holes 31a, the visually impaired people can recognize which type of operation button the first call button 4a is.

Similarly, the second sound emission holes 31b are arranged so that the visually impaired people can identify the type of the second call button 4b when the visually impaired people touch the face plate 3 from the front surface side. Therefore, by touching the second sound emission holes 31b, the visually impaired people can recognize which type of operation button the second call button 4b is.

The first sound emission holes 31a are positioned adjacent to the first call button 4a. The respective first sound emission holes 31a are arranged at intervals one by one so as to indicate an upward arrow as a whole. The visually impaired people may touch the first sound emission holes 31a to recognize that the mode of the first sound emission holes 31a indicates an upward arrow. Therefore, the visually impaired people can recognize that the type of the first call button 4a is an operation button for calling an ascending car to the landing.

The second sound emission holes 31b are positioned adjacent to the second call button 4b. The respective second sound emission holes 31b are arranged at intervals one by one so as to indicate a downward arrow as a whole. The visually impaired people may touch the second sound emission holes 31b to recognize that the mode of the second sound emission holes 31b indicates a downward arrow. Therefore, the visually impaired people can recognize that the type of the second call button 4b is an operation button for calling a descending car to the landing.

Further, the plurality of sound emission holes 31 may be arranged so that the type of the operation button 4 can be identified not only when the visually impaired people touch the face plate 3 from the front surface side, but also when the physically unimpaired people view the face plate 3 from the front surface side.

For example, when the plurality of sound emission holes 31 are configured as described above, the physically unimpaired people may view the first sound emission holes 31a and the second sound emission holes 31b to recognize that the mode of the first sound emission holes 31a indicates an upward arrow and the mode of the second sound emission holes 31b indicates a downward arrow. Therefore, the physically unimpaired people can recognize that the first call button 4a is an operation button for calling an ascending car to the landing, and that the second call button 4b is an operation button for calling a descending car to the landing.

Through the device of the arrangement of the plurality of sound emission holes 31 formed in the face plate 3, the passenger can identify the type of the operation button 4 visually and by touching with his or her finger.

The light-emitting device 6 is present in the casing 2. Specifically, as illustrated in FIG. 2, the support portion 7 is mounted to the back surface of the face plate 3. The support portion 7 is configured to support the light-emitting device 6 so that the light-emitting device 6 is opposed to the back surface of the face plate 3 with an interval between the light-emitting device 6 and the face plate 3. With this configuration, when the opening portion 21 is closed with the face plate 3, the light-emitting device 6 is present in the casing 2. Further, the light-emitting device 6 is configured with use of, for example, an LED, which outputs light passing through the plurality of sound emission holes 31 from the inside of the casing 2 as a response to the operation on the operation button 4.

In this case, for example, when the plurality of sound emission holes 31 are configured as described above, a first light-emitting device 6a opposed to the first sound emission holes 31a and a second light-emitting device 6b opposed to the second sound emission holes 31b are provided as the light-emitting device 6.

The first light-emitting device 6a is configured to output light passing through the first sound emission holes 31a as a response to the operation on the first call button 4a. The second light-emitting device 6b is configured to output light passing through the second sound emission holes 31b as a response to the operation on the second call button 4b.

With this configuration, when the passenger presses the operation button 4 to register a call, the light output from the light-emitting device 6 passes through the plurality of sound emission holes 31 corresponding to the operation button 4 to be seen by the passenger. Therefore, the passenger may see the light to recognize that the call has been registered.

As described above, according to the landing operation panel of the first embodiment, the plurality of sound emission holes formed in the face plate are arranged so that the type of the operation button can be identified when the face plate is touched from the front surface side.

With this, even without separately forming Braille protrusions and the like on the front surface of the face plate having the plurality of sound emission holes formed therein, the visually impaired people can use the landing operation panel.

The front surface of the face plate has the plurality of sound emission holes formed therein, and hence the passenger can easily hear the sound of the acoustic device without increasing the volume of the acoustic device. Further, the volume of the acoustic device can be suppressed, and hence the power consumption of the acoustic device can be reduced as a result. Further, the acoustic device can be downsized, and thus the landing operation panel can be downsized. Further, the sound of the acoustic device can be easily heard, and hence not only the physically unimpaired people but also the visually impaired people can easily recognize the button response.

Further, the plurality of sound emission holes are arranged so that the type of the operation button can be identified not only when the face plate is touched from the front surface side but also when the face plate is viewed from the front surface side.

With this, regarding the type of the operation button, the visually impaired people can identify the type based on the sense of touch, and the physically unimpaired people can identify the type based on the sense of vision. Further, the plurality of sound emission holes formed in the face plate are used as a substitute for display characters for the physically unimpaired people and Braille for the visually impaired people, which indicate the type of the operation button, and hence the structure of the operation button can be simplified.

Further, the landing operation panel is configured to further include the light-emitting device configured to output light passing through the plurality of sound emission holes from the inside of the casing.

With this, by viewing the light from the plurality of sound emission holes corresponding to the operation button, the physically unimpaired people can more easily recognize the button response. Further, the structure of the operation button is not required to be processed so as to cause the operation button to transmit light as a response to the operation on the operation button, and thus the operation button can be made of an opaque material. As a result, the structure of the operation button can be more simplified.

### Second Embodiment

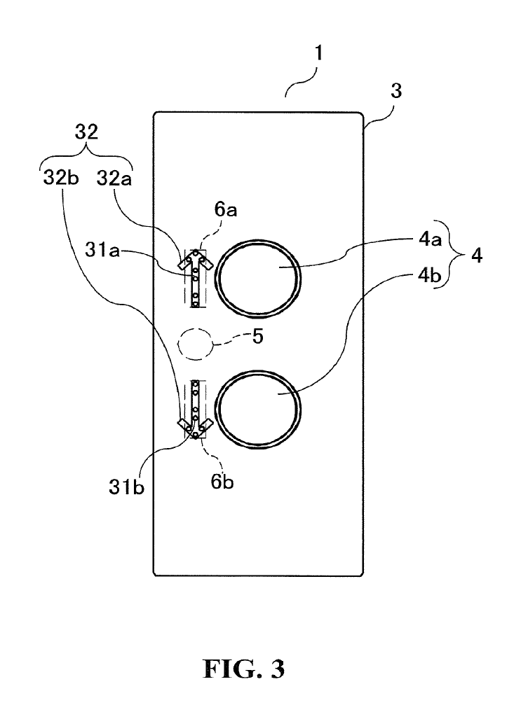

In a second embodiment of the present invention, description is given of the landing operation panel 1 further including a geometric-shape portion 32 that is formed on the front surface of the face plate 3 with respect to the configuration of the above-mentioned first embodiment. FIG. 3 is a front view for illustrating the elevator landing operation panel 1 according to the second embodiment of the present invention. In the second embodiment, description of similarities to the above-mentioned first embodiment is omitted, and differences from the above-mentioned first embodiment are mainly described.

On the front surface of the face plate 3, the geometric-shape portion 32 is formed. The geometric-shape portion 32 is colored and has a shape that enables the type of the operation button to be identified when the passenger views the face plate 3 from the front surface side. Further, the plurality of sound emission holes 31 are arranged on the geometric-shape portion 32. Further, the plurality of sound emission holes 31 arranged on the geometric-shape portion 32 are arranged so that the type of the operation button 4 can be identified when the visually impaired people touch the face plate 3 from the front surface side.

In this case, for example, when the operation button 4 is configured as illustrated in FIG. 3, a first geometric-shape portion 32a corresponding to the first call button 4a and a second geometric-shape portion 32b corresponding to the second call button 4b are formed on the front surface of the face plate 3 as the geometric-shape portion 32.

The shape of the first geometric-shape portion 32a indicates an upward arrow, and the shape of the second geometric-shape portion 32b indicates a downward arrow. Therefore, when the passenger views the first geometric-shape portion 32a, the passenger recognizes that the type of the first call button 4a is an operation button for calling an ascending car to the landing. Further, when the passenger views the second geometric-shape portion 32b, the passenger recognizes that the type of the second call button 4b is an operation button for calling a descending car to the landing.

Further, each of the first geometric-shape portion 32a and the second geometric-shape portion 32b is colored. Therefore, even a passenger with weak sight having difficulty in visually recognizing the first sound emission holes 31a and the second sound emission holes 31b can identify the type of each of the first call buttons 4a and the second call buttons 4b.

The respective first sound emission holes 31a are arranged on the first geometric-shape portion 32a at intervals one by one so as to indicate an upward arrow as a whole. Further, the respective second sound emission holes 31b are arranged on the second geometric-shape portion 32b at intervals one by one so as to indicate a downward arrow as a whole.

As described above, according to the landing operation panel of the second embodiment, the plurality of sound emission holes of the above-mentioned first embodiment are arranged on the geometric-shape portion, which is colored, and has a shape that enables the type of the operation button to be identified.

With this, as compared to the configuration of the above-mentioned first embodiment, the visibility of the arrangement of the sound emission holes is more improved. Further, even a passenger with weak sight using the elevator and having difficulty in visually recognizing the sound emission holes can identify the type of the operation button by viewing the colored geometric-shape portion.

### Third Embodiment

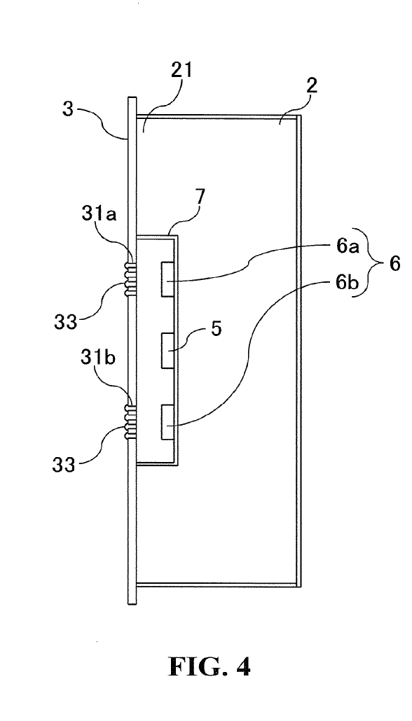

In a third embodiment of the present invention, description is given of the landing operation panel 1 further including a light transmitting member 33 mounted in each of the plurality of sound emission holes 31 with respect to the configuration of the above-mentioned first embodiment. FIG. 4 is a sectional view for illustrating the elevator landing operation panel 1 according to the third embodiment of the present invention. FIG. 4 corresponds to a sectional view for illustrating a configuration further including light transmitting members 33 with respect to the above-mentioned configuration of FIG. 2. Further, in the third embodiment, description of similarities to the above-mentioned first embodiment is omitted, and differences from the above-mentioned first embodiment are mainly described.

The light transmitting member 33 configured to transmit light output from the light-emitting device 6 is mounted in each of the plurality of sound emission holes 31 formed in the faceplate 3 under a state in which the light transmitting member 33 is protruded from the front surface of the face plate 3. The light transmitting member 33 is made of, for example, a synthetic resin, glass, or other light transmitting materials.

In this case, for example, when the light transmitting member 33 is mounted in each of the plurality of sound emission holes 31 with respect to the above-mentioned configuration of FIG. 2, as illustrated in FIG. 4, the light transmitting member 33 is mounted in each of the first sound emission holes 31a, and the light transmitting member 33 is further mounted in each of the second sound emission holes 31b.

When the light transmitting member 33 is mounted in each of the plurality of sound emission holes 31, the light transmitting member 33 itself functions as a protrusion that protrudes from the front surface of the faceplate 3. Therefore, the visually impaired people may touch the light transmitting members 33 to feel a sense similar to that obtained when touching Braille protrusions formed in the related-art landing operation panel.

With such a configuration, the passenger can recognize the arrangement of the light transmitting members 33 mounted in the plurality of sound emission holes 31, respectively, not only by viewing but also by touching with his or her finger, and hence the type of the operation button 4 can be identified similarly to the above-mentioned first embodiment.

Further, when the passenger presses the operation button 4 to register a call, the passenger can see light output from the light-emitting device 6 to pass through the plurality of sound emission holes 31 and the light transmitting members 33 corresponding to the pressed operation button 4. Therefore, the passenger may see the light to recognize that the call has been registered.

The height of protrusion of the light transmitting member 33 itself from the front surface of the face plate 3 may be adjusted so as to be, for example, equivalent to the height of the Braille protrusion formed in the related-art landing operation panel.

As described above, according to the landing operation panel of the third embodiment, the light transmitting member is mounted in each of the plurality of sound emission holes of the above-mentioned first embodiment under a state in which the light transmitting member is protruded from the front surface of the face plate.

With this, the visually impaired people can more easily identify the type of the operation button as compared to the above-mentioned first embodiment because the visually impaired people touch not the sound emission hole itself but the light transmitting member mounted in the sound emission hole. Further, the visually impaired people can identify the type of the operation button in a sense similar to that obtained when touching Braille protrusions formed in the related-art landing operation panel.

In the first to third embodiments, there is exemplified a case in which the plurality of sound emission holes 31 corresponding to the operation button 4 are formed at positions adjacent to the operation button 4, but the present invention is not limited thereto, and the plurality of sound emission holes 31 may be formed at any positions of the face plate 3 with respect to the operation button 4.

Further, in the first to third embodiments, there is exemplified a case in which the operation button 4 has a function of the call button for calling a car and the plurality of sound emission holes 31 are arranged so as to indicate an arrow representing the movement direction of the car. However, the present invention is not limited thereto. The operation button 4 may have a function as a floor button for designating the destination floor, and the plurality of sound emission holes 31 may be arranged so as to indicate a number, a character, Braille, or a sign as long as the type of the operation button 4 can be identified.

Further, the first to third embodiments have been individually described, but the configuration examples disclosed in the respective first to third embodiments can be combined as appropriate.

Further, in the first to third embodiments, there is exemplified a case in which the invention of the subject application is applied to the landing operation panel 1 installed at the landing of the elevator, but the invention of the subject application may be applied to a car operation panel installed at the car of the elevator.

1. An elevator operation panel, comprising:
a casing having an opening portion;
an acoustic device configured to output a sound from an inside of the casing;
a face plate having formed therein a plurality of sound emission holes for allowing the sound output from the acoustic device to pass therethrough, and having a back surface that faces the casing to close the opening portion; and
an operation button formed on the face plate and to be operated to cause an elevator to perform a specific operation,
the plurality of sound emission holes being arranged so that a type of the operation button is identifiable when the face plate is touched from a front surface side.

2. The elevator operation panel according to claim 1, wherein the plurality of sound emission holes are arranged so that the type of the operation button is identifiable even when the face plate is viewed from the front surface side.

3. The elevator operation panel according to claim 2, further comprising a light-emitting device configured to output light that passes through the plurality of sound emission holes from the inside of the casing.

4. The elevator operation panel according to claim 1,
wherein the front surface of the face plate has a geometric-shape portion, which is colored, and has a shape that enables the type of the operation button to be identified when the face plate is viewed from the front surface side, and
wherein the plurality of sound emission holes are arranged on the geometric-shape portion.

5. The elevator operation panel according to claim 1, further comprising a light transmitting member mounted in each of the plurality of sound emission holes under a state in which the light transmitting member is protruded from the front surface of the face plate.
